(19) United States
(12) Patent Application Publication
(10) Pub. No.: US 2025/0189930 A1
(43) Pub. Date: Jun. 12, 2025

(54) DEVICE FOR LOCKING A PUSH-BUTTON OF A WATCHCASE

(71) Applicant: Harry Winston SA, Plan-les-Ouates (CH)

(72) Inventor: Steven DENOREAZ, Bellefontaine (FR)

(73) Assignee: Harry Winston SA, Plan-les-Ouates (CH)

(21) Appl. No.: 18/901,035

(22) Filed: Sep. 30, 2024

(30) Foreign Application Priority Data
Dec. 7, 2023 (EP) 23214943.5

(51) Int. Cl. G04B 3/04

(52) U.S. Cl. CPC G04B 3/046; G04B 3/048

(57) ABSTRACT

A device for locking a push-button in a rest position, including a push-button intended to be slidingly movably engaged in a middle between an active position and a rest position, and a control member cooperating with a blocking element so that, when the control member occupies a locking position, the blocking element immobilises the push-button in the rest position, and when the control member occupies a release position, the blocking element enables movement of the push-button from its rest position.

### TECHNICAL FIELD OF THE INVENTION

The invention relates to the field of watchmaking and in particular watchcases. The invention relates in particular to a device for locking a push-button of a watchcase.

### TECHNOLOGICAL BACKGROUND

Watches comprising a watch movement equipped with some complications have a case equipped with at least one push-button whose purpose is to select, activate or correct a function of the said watch movement.

The most commonly encountered push-buttons are in the form of buttons extending outside the middle. These push-buttons are advantageously easy and quick to access when the watch is worn. However, their prominence can lead to unintentional operation.

To solve this problem, some push-buttons are in the form of correctors flush with the surface of the middle of the watch. These push-buttons need to be activated by the tip of a dedicated tool to prevent accidental operation. Still with the same objective in mind, some push-buttons are located in areas of the watchcase that are relatively difficult to access and require the watch to be removed from the user in order to be activated. Using these push-buttons can therefore be particularly tedious.

It is clear that a trade-off has to be found between ease of use of a push-button when the watch is worn and making it safe to operate.

The present invention aims to solve this problem.

### SUMMARY OF THE INVENTION

To this end, the invention relates to a device for locking a push-button in a rest position, comprising a push-button intended to be slidingly movably engaged in a middle between an active position and a rest position, and a control member cooperating with a blocking element so that, when the control member occupies a locking position, the blocking element causes the push-button to be immobilised in the rest position, and when the control member occupies a release position, the blocking element enables movement of the push-button from its rest position.

Thus, the present invention makes it easier to lock and unlock a push-button, while being able to be applied to push-buttons that are simple and quick to use when the watch is worn and do not require any tools to be activated.

Furthermore, the device implements very few components, making it very simple to build.

In particular embodiments, the invention may further include one or more of the following features, considered alone or in any technically possible combination.

In particular embodiments, when the control member occupies the release position, the locking element is held against the control member under the effect of an elastic return force.

In particular embodiments, the push-button includes an excrescence intended to engage, when the push-button occupies the active position, in a cavity with a complementary shape extending into the middle, the control member forcing the blocking element to close off this cavity when it occupies the locking position, the latter being cleared when it occupies the release position.

In particular embodiments, the blocking element is formed by an elastic blade extending between two ends, a first of which is arranged against the control member and a second of which is intended to clear or close off the cavity depending on the position of the control member.

In particular embodiments, the blocking element is configured so that, when the control member is moved towards the locking position, it applies a force on the first end of the blocking element, causing deformation thereof such that the second end of said blocking element is moved in translation according to a first direction, and is configured so that, when the control member is moved towards the release position, the blocking element is deformed under the effect of the elastic return force, such that its second end is moved in translation according to a second direction opposite to the first direction.

In particular embodiments, the control member is formed by a crown fastened to a free end of a winding stem and including a skirt against which the blocking element rests.

According to another object, the present invention relates to a watchcase comprising a middle, a glass and a back defining an internal volume intended to receive a watch movement, the case further comprising a locking device as described before, the middle being configured to guide the movement of the blocking element, the latter being arranged outside the internal volume.

### BRIEF DESCRIPTION OF THE FIGURES

Other features and advantages of the invention will become apparent from the following detailed description, which is given as example and is by no means limiting, with reference to the appended drawings wherein:

FIG. 1 shows a detailed view of a watchcase comprising a device for locking a push-button according to a preferred embodiment of the invention, wherein the push-button occupies a rest position and a control member occupies a release position enabling movement of the push-button from the rest position towards an active position;

FIG. 2 shows the detail view of FIG. 1, wherein the control member occupies a locking position immobilising the push-button in the rest position;

FIG. 3 shows the detail view of FIG. 1, wherein the push-button is in the active position.

Note that the figures are not necessarily drawn to scale for clarity.

### DETAILED DESCRIPTION OF THE INVENTION

The present invention relates to a device 10 for locking a push-button of a watchcase in a rest position and to a watchcase 20 including said locking device 10.

The watchcase 20 defines an internal volume 22 in which it is intended to house a watch movement, in a manner known to the person skilled in the art. In particular, the internal volume 22 is defined in particular by a middle 21, a glass and a back of the watchcase 20.

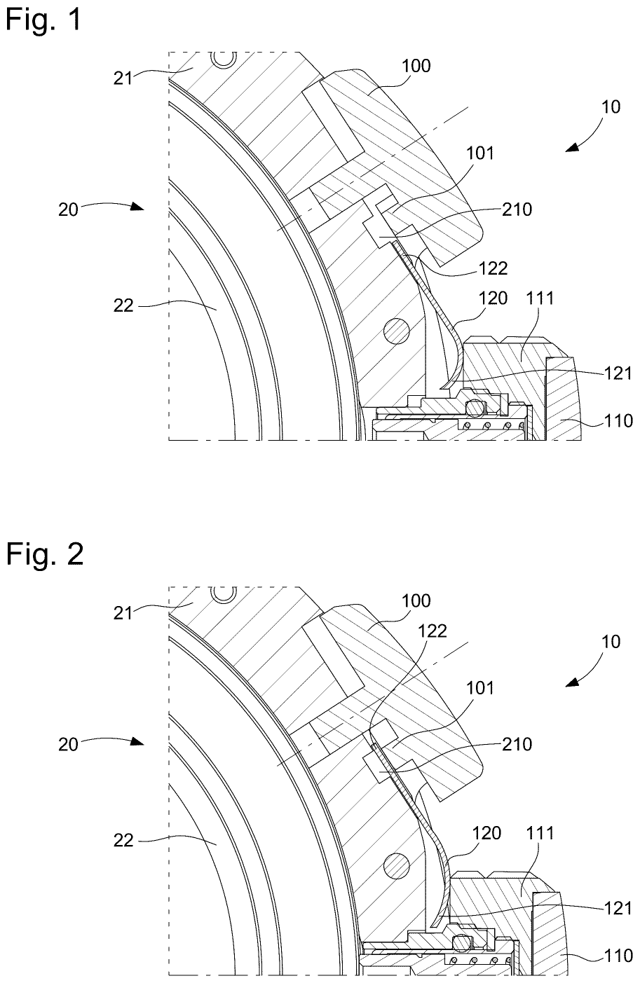

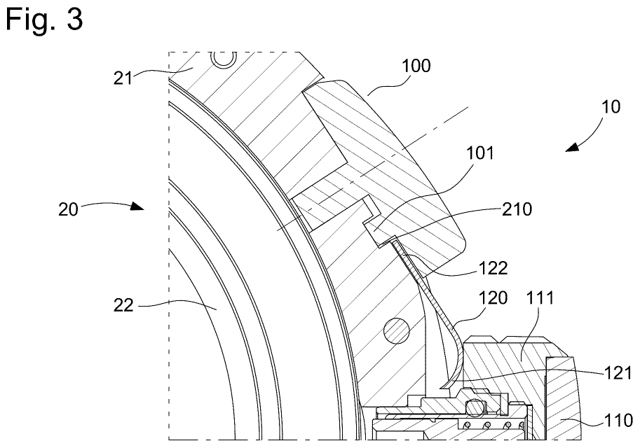

The locking device 10 according to the invention comprises a push-button 100 intended to be engaged slidingly movable in a middle 21 of the watchcase 20, according to a direction oriented towards the internal volume 22 of the case. The push-button 100 is intended to be activated by a user to occupy an active position, as shown in FIG. 3, in order to act on the watch movement, for example to select, activate or correct a function of the watch movement. The push-button 100 is biased into a rest position, as shown in FIG. 1, by a spring (not shown in the figures), for example in a manner known to the person skilled in the art.

The locking device 10 further includes a control member 110 intended to be engaged in the middle 21 so as to be rotatable and/or pivotable between a locking position and a release position.

In particular, the locking device 10 includes a blocking element 120 arranged so as to cooperate with the control member 110 so that, when the control member 110 occupies the release position, the blocking element 120 enables movement of the push-button 100 from its rest position, as shown in FIG. 1, towards its active position, as shown in FIG. 3, and when the control member 110 occupies the locking position, the blocking element 120 immobilises the push-button 100 in the rest position, as shown in FIG. 2.

In a preferred embodiment, the push-button 100 includes an excrescence 101, for example in the form of a stud, intended to engage in a cavity 210 with a complementary shape extending into the case middle 21, when the push-button 100 occupies the active position, as shown in FIG. 3. The blocking element 120 is configured to close off this cavity 210 when the control member 110 occupies the locking position, as shown in FIG. 2. Thus, the blocking element 120 forms a stop against which the excrescence 101 rests.

Advantageously, when the control member 110 occupies the release position, the blocking element 120 is held, under the effect of an elastic return force, against said control member 110. Consequently, when it moves towards the locking position, the control member 110 forces the blocking element 120 to deform against the elastic return force.

Preferably, the blocking element 120 is formed by an elastic blade extending between two ends, a first 121 of which is arranged against the control member 110 and a second 122 of which is intended to clear or close off the cavity 210.

More specifically, the blocking element 120 is configured so that, when the control member 110 is moved towards the locking position, it applies, on the first end 121 of the blocking element 120, a force causing deformation thereof such that the second end 122 of said blocking element 120 is moved in a translational movement according to a first direction so that it closes off the cavity 210. In a complementary manner, the blocking element 120 is configured so that, when the control member 110 is moved towards the release position, the blocking element 120 is deformed under the effect of the elastic return force, such that its second end 122 is moved in a translational movement according to a second direction opposite to the first direction, so that it clears the cavity 210, i.e. it no longer faces the cavity 210.

Preferably, the control member 110 is formed by a crown fastened to a free end of a winding stem. The crown includes a skirt 111 against which the first end 121 of the blocking element 120 rests. Thus, whether the crown is moved according to a helical or rectilinear trajectory, respectively if the crown is screwed in/out or if the crown is pulled in/pushed out, the blocking element 120 will be operated in a similar manner. In particular, in the preferred embodiment of the invention, when the control member occupies the locking position, it is closer to the middle than when it occupies the release position, as illustrated in FIGS. 1 and 3.

Advantageously, the movement of the blocking element 120 is guided by the middle 21 and is arranged outside the internal volume 22, as shown in FIGS. 1 to 3. In particular, the case middle 21 is configured so as to form a guide track ensuring guidance of the blocking element 120 while ensuring fastening thereof it to the case.

It should be noted that, in the present invention, there is no kinematic connection between the push-button 100 and the control member 110. This arrangement allows simplifying the locking device 10 as much as possible.

Moreover, the fact that the blocking element 120 is arranged outside the internal volume 22 allows adapting the invention to any existing watch movement without requiring any modifications to the latter.

More generally, it should be noted that the implementations and embodiments considered hereinabove have been described as non-limiting examples, and that other variants are therefore conceivable.

For example, the invention may include several push-buttons and as many blocking elements, each of these being capable of immobilising a push-button in its rest position. In particular, the invention may include two push-buttons arranged respectively on either side of the crown, the blocking elements being arranged to work symmetrically and lock the push-buttons simultaneously.

1. A device for locking a push-button in a rest position, wherein the device comprises a push-button configured to be slidingly movably engaged in a middle between an active position and a rest position, and a control member cooperating with a blocking element so that, when the control member occupies a locking position, the blocking element immobilises the push-button in the rest position, and when the control member occupies a release position, the blocking element allows the push-button to move from its rest position, the push-button including an excrescence configured to engage, when the push-button occupies the active position, in a cavity with a complementary shape extending in the middle, the control member forcing the blocking element to close off this cavity when control member occupies the locking position, the latter being released when control member occupies the release position, the blocking element being formed by an elastic blade extending between two ends, a first of which is arranged against the control member and a second of which is configured to clear or close off the cavity depending on the position of the control member.

2. The locking device according to claim 1, wherein when the control member occupies the release position, the blocking element is held against the control member under the effect of an elastic return force.

3. The locking device according to claim 1, wherein when the control member occupies the release position, the blocking element is held against the control member under the effect of an elastic return force, the blocking element being configured so that, when the control member is moved towards the locking position, it the control member applies, on the first end of the blocking element, a force causing deformation thereof such that the second end of said blocking element is moved in translation according to a first direction, and being configured so that, when the control member is moved towards the release position, the blocking element is deformed under the effect of the elastic return force, such that its second end is moved in translation according to a second direction opposite to the first direction.

4. The locking device according to claim 1, wherein the control member is formed by a crown fastened to a free end of a winding stem and including a skirt against which the blocking element rests.

5. A watchcase comprising a middle, a glass and a back defining an internal volume configured to receive a watch movement, the case further comprising a locking device according to claim 1, the middle being configured to guide the movement of the blocking element, the latter being arranged outside the internal volume.
